(19) United States
(12) Patent Application Publication
(10) Pub. No.: US 2008/0276694 A1
(43) Pub. Date: Nov. 13, 2008

(54) Analytical Methods For 2-Deoxy-D-Glucose

(75) Inventor: Michael Li, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Threshold Pharmaceutical, Inc., Redwood City, CA (US)

(21) Appl. No.: 11/597,860

(22) PCT Filed: Jun. 22, 2005
(86) PCT No.: PCT/US2005/022299

§ 371 Date: Jun. 26, 2007

Related U.S. Application Data
(60) Provisional application No. 60/582,564, filed on Jun. 23, 2004.

(51) Int. Cl. G01N 30/02

(52) U.S. Cl. 73/61.58

(57) ABSTRACT

2-Deoxy-2-D-glucose (2-DG) concentration and purity can be measured in a sample of crystalline or liquid by HPLC with accuracy and precision suitable for analysis of active pharmaceutical ingredient and drug product.

### BACKGROUND OF THE INVENTION

1. Field of Invention

The present invention provides methods for analysis of purity and concentration of 2-deoxy-D-glucose (2-DG), especially in preparations intended for therapeutic use, and so relates to the fields of chemistry, biology, pharmacology, and medicine.

2. Description of Related Art

2-Deoxy-D-glucose (2-DG) has been studied to determine if the compound has potential application as an anticancer agent (see Blough et al., 1979, JAMA 241 (26): 2798, incorporated herein by reference). Recent advances, as described in PCT patent application No. US04/000530 and U.S. Pat. No. 6,670,330, both of which are incorporated herein by reference, that are being implemented in ongoing clinical trials indicate that 2-DG should prove to be a useful anticancer agent. Employing 2-DG as an active pharmaceutical ingredient (API) in a drug product requires an accurate method for determining the concentration and purity of 2-DG.

HPLC analysis has been used to determine the concentration and purity of glucoase, a 2-DG analog. Columns and chromatographic conditions that have been described for the analysis of glucose using a refractive index (RI) detector are shown in Table 1, below.

TABLE 1

| | | | Mobile | | |
|---|---|---|---|---|---|
| Vendor | Column | Temperature | Phase | Flow rate | |
| Alltech | Astec Amino | Ambient | ACN:water | 1 | mL/min |
| | 250-4.6 mm | | (75:25) | | |
| | 5-μm | | | | |
| Alltech | Hypersil | Ambient | ACN:water | 0.5 | mL/min |
| | APS-2 | | (80:20) | | |
| | 100 × 3.2 mm | | | | |
| | 5-μm | | | | |
| Phenomenex | Luna Amino | 40° C. | ACN:water | 3 | mL/min |
| | 250 × 4.6 mm | | (80:20) | | |
| | 5-μm | | | | |
| Phenomenex | Rezex | 85° C. | Water | 0.6 | mL/min |
| | RCM-Mono- | | | | |
| | saccharide | | | | |
| | 300 × 7.8 mm | | | | |

One of the methods used for determining the purity of 2-DG in a sample is gas chromatography (GC; see Blough et al., supra, page 2799). However, 2-DG is a non volatile, high melting solid and needs to be transformed chemically into a volatile derivative that can be evaporated for analysis by GC. The transformation procedure involves reacting 2-DG with a trimethylsilylating agent, and the purity of its volatile trimethylsilylated derivative is actually analyzed by GC. The purity of 2-DG in the sample is thus indirectly inferred from the analysis of the derivative. In one approach, 2-DG has been reacted with trimethylsilylimidazole and pyridine for five minutes in an all glass reaction-vessel, prior to GC analysis (Blough et al., supra).

The drawbacks to this method include the following. Because there are four hydroxy groups in 2-DG that can be trimethylsilylated, each of them has to react with trimethylsilyl chloride (or any other trimethylsilylating agent), thus yielding a single product (which is analyzed in comparison to other components in the chromatogram), to describe the purity of 2-DG accurately. If the silylation reaction is incomplete, the formation of partially silylated derivatives can erroneously diminish the measured purity or concentration of the 2-DG in the sample. Also, the silylation product has to be stable during the process of evaporation and passage through the column at high temperatures, and the reactive 1′-TMS ether may become deprotected during this process.

In another method, 2-DG in rat serum has been analyzed by HPLC following a post column fluorescence derivatization (see Umegae et al., 1990, Chem. Pharm. Bull. 38 (4): 963-5, incorporated herein by reference). In this method, the sugars are converted into fluorescent derivatives by reaction with meso-1,2-bis(4-methoxyphenyl)ethylenediamine in an alkaline medium after separation on a strong anion exchange column (TSK gel Sugar AXG), and the fluorescent analogs are analyzed by a fluorescent detector. The detection limit in one application was, at a signal-to-noise ratio of 3, 0.52 nmol/mL. Again, the requirement of a reactive step and the measurement of an entity different from the actual analyte are among the drawbacks of this method.

Another method for analyzing the presence of tritiated ³H-2-DG in rat muscle using chromatography has been reported (see Wallis et al., 2002, Diabetes, 51:3492, incorporated herein by reference). In this method, free and phosphorylated ³H-2-DG are separated by ion exchange chromatography using an anion exchange resin (AG1-X8). Biodegradable counting scintillant, BCA (Amersham), is added to each radioactive sample and radioactivity determined using a scintillation counter (LS3801; Beckman). However, the radioactivity of 2-DG is used as a read-out, so the method is useful only for radio-labeled 2-DG.

Another method for determining 2-DG purity, in topical formulations, that involves HPLC has been employed with ultraviolet detection (UV) at 195 nm (see Hughes et al., 1985, J. Chromatogr. 331(1):183-6, incorporated herein by reference). 2-DG does not possess a chromophore absorbing above 200 nm, and a very low wave-length of 195 was chosen by the scientists reporting the method for the purpose of analysis. Columns that have been used in the method are a μBondapak 10 μm NH₂ column and a Varian Micropak 10 μm NH₂ column. The eluent used was 85% MeCN/H₂O. The retention time of 2-DG reported in one application was about 4 minutes. Such a retention time is typically too short to observe impurities present in the sample, especially if the impurities are structurally closely related compounds like glucose.

There remains a need for methods for analyzing the purity and concentration of 2-DG that do not require derivatization, provide accurate results, especially at low concentrations, and are applicable to crystalline 2-DG. The present invention meets these needs.

### BRIEF SUMMARY OF THE INVENTION

The present invention provides a method of separating 2-DG employing anion exchange chromatography wherein the anion exchange chromatography uses a poly(styrene-divinylbenzene) based polymer as a stationary phase. In one embodiment, the poly(styrene-divinylbenzene) based stationary phase contains ammonium groups. In a related embodiment, the ammonium group is a trimethylammonium group. In one embodiment, a poly(methylacrylamido propyl trimethylammonium salt) based polymer provides the trimethylammonium employed in the stationary phase. Examples for separating 2-DG employing anion exchange chromatography wherein the anion exchange chromatography uses poly(styrene-divinylbenzene) based stationary phases includes anion exchange chromatography employing RCX-10, RCX-30, and Aminex HPX-87X anion exchange columns. Examples of separating 2-DG employing anion exchange chromatography wherein the anion exchange chromatography uses poly(styrene-divinylbenzene) based stationary phases containing trimethylammonium groups include anion exchange chromatography employing RCX-10 and RCX-30 anion exchange columns.

In one aspect, the present invention provides an HPLC-based method for analyzing the purity of crystalline 2-DG, said method comprising the steps of: (a) dissolving said crystalline 2-DG in an aqueous solution; (b) chromatographing a sample of said aqueous 2-DG solution on an ion exchange column using an eluent selected from the group consisting of water, aqueous alkali, and aqueous acid as; (c) measuring an amount of 2-DG and any impurities in said sample after said chromatography by means of a detector that generates a signal proportional to the amount of said 2-DG in said sample; and (d) determining the purity of said crystalline 2-DG by comparing the signal generated by said 2-DG with any signal generated by said impurities in said sample.

In one embodiment, an anion exchange column and aqueous alkali eluent are employed. In another embodiment, an ion exchange column and aqueous acid eluent are employed. In another embodiment, an ion exchange column and water eluent are employed. In another embodiment, an anion exchange column and aqueous alkali eluent are employed, and an RI detector or a pulsed amperometric detector (PAD) is used to generate the signal. In one embodiment, an RI detector or a pulsed amperometric detector is used to generate the signal, and the crystalline 2-DG solution analyzed contains between about 1 μg/mL and 10 mg/mL of crystalline 2-DG.

In another aspect, the present invention provides an HPLC method for analyzing the purity of 2-DG in an aqueous solution, said method comprising the steps of: (a) chromatographing a sample of said aqueous 2-DG solution on an ion exchange column using an eluent selected from the group consisting of water, aqueous alkali, and aqueous acid; (b) measuring an amount of 2-DG and any impurities in said sample after said chromatography by means of a detector that generates a signal proportional to the amount of said 2-DG in said sample; (c) determining the purity of said 2-DG by comparing the signal generated by said 2-DG with any signal generated by said impurities in said sample. In one embodiment, the detector is a detector other than a UV detector.

In one embodiment, an anion exchange column and aqueous alkali eluent are employed. In another embodiment, an ion exchange column and aqueous acid eluent are employed. In another embodiment, an ion exchange column and water eluent are employed. In another embodiment, an anion exchange column and aqueous alkali eluent are employed, and an RI detector or a pulsed amperometric detector PAD is used to generate the signal. In another embodiment, an RI detector or a pulsed amperometric detector is used to generate the signal, and said 2-DG solution contains between about 1 μg/mL and 10 mg/mL of 2-DG.

### BRIEF DESCRIPTION OF THE FIGURES

FIG. 1 shows a chromatogram for 2-DG (2 mg/mL) and glucose (2 mg/mL).

FIGS. 2A and 2B show chromatograms for blank injections of water (FIG. 2A) and mobile phase (see FIG. 2B).

FIGS. 3A and 3B show chromatograms. FIG. 3A is a chromotogram for a placebo (1.8 mg/ml methylparaben and 0.2 mg/ml propylparaben); FIG. 3B is a chromatogram for the same sample after degradation by exposure to 70° C. for 1 day.

FIG. 4 shows a chromatogram for 2-deoxyglucose (2-DG) after 35 days at 60° C.

FIG. 5 shows a chromatogram for 2-DG after 23 days at 60° C.

FIGS. 6A and 6B show chromatograms for 2-DG after degradation by incubation for 5 days at 60° C. at pH 2, and pH 5, respectively.

FIGS. 7A and 7B show chromatograms for oxidized 2-DG samples. The sample in FIG. 7A is 5 ml 2-DG+50 μl H₂O2 after storage at 60° C. for 17 hours. The sample in FIG. 7B is 5 ml 2-DG+100 μl H₂O2 after storage at 60° C. for 17 hours.

FIGS. 8A and 8B are chromatograms for 20 mg/ml 2-DG samples, after being degraded by exposure to intense fluorescent light for 35 days.

FIG. 9 shows average peak area for 1 to 3 mg/ml samples of 2-DG in water.

FIGS. 10A and 10B show average peak area for 0.1-1.2 mg/ml glucose in assays run with 10 μl samples (FIG. 10A) and for 0.01-0.12 glucose in assays using 80 μl samples (FIG. 10B).

FIG. 11 shows a chromatogram for 10 μg/ml glucose.

### DETAILED DESCRIPTION OF THE INVENTION

### Example 1

### Assay of 2-DG and Related Compounds in API and Drug-Product

This example illustrates how 2-DG purity was assessed in a mixture containing 2-DG and glucose in accordance with an embodiment of the method of the invention in which aqueous NaOH was the mobile phase, an anion exchange column was the stationary phase, an RI detector was employed, and the concentration of 2-DG in the 2-DG solution analyzed was about 2 mg/mL. A sample of 2-DG drug product was prepared by dissolving API grade 2-DG into an aqueous solution containing methylparaben (0.18%) and propylparaben (0.02%). Chromatographic parameters analyzed to illustrate the method included system linearity, accuracy, system precision, system suitability, limits of detection and quantitation, and robustness and ruggedness.

The general procedure for HPLC employed an isocratic HPLC method, with an RI detector equipped with an anion-exchange column (Hamilton RCX-10, 250×4.1 mm, 0 7-μm) controlled at 30° C. The mobile phase was 18 mM NaOH in water and a flow rate of 0.7 mL/min yielded baseline resolution of 2-DG and glucose.

The method was performed using a Shimadzu HPLC system equipped with an automatic data acquisition system (ChromPerfect), a Shimadzu pump (Model LC-10AD), a Shimadzu autosampler (Model SIL-10A) and an RI detector (Agilent model 1100). The materials employed in the analyses, along with their suppliers are listed below:

| Sodium hydroxide | ACS Grade |
|---|---|
| 2-deoxy-D-glucose | Ferro-Pfanstiehl |
| 2-deoxy-D-glucose | Ferro-Pfanstiehl |
| 2-deoxy-D-glucose* | Sigma |
| Glucose* | Sigma |
| Methylparaben | Sigma |
| Propylparaben | Sigma |
| Water | Milli-Q water |

*The reference standard employed in the experiment.

### Determination of Specificity

The placebo solutions and the solutions used for specificity and stability measurements were prepared as follows. The placebo solution was prepared by warming an appropriate mixture of methylparaben and propylparaben in water to about 70° C. and diluting this solution quantitatively. A solution of API 2-DG was prepared by dissolving crystalline 2-DG in water. A solution of 2-DG drug-product was prepared by dissolving a sample of crystalline 2-DG in the placebo solution.

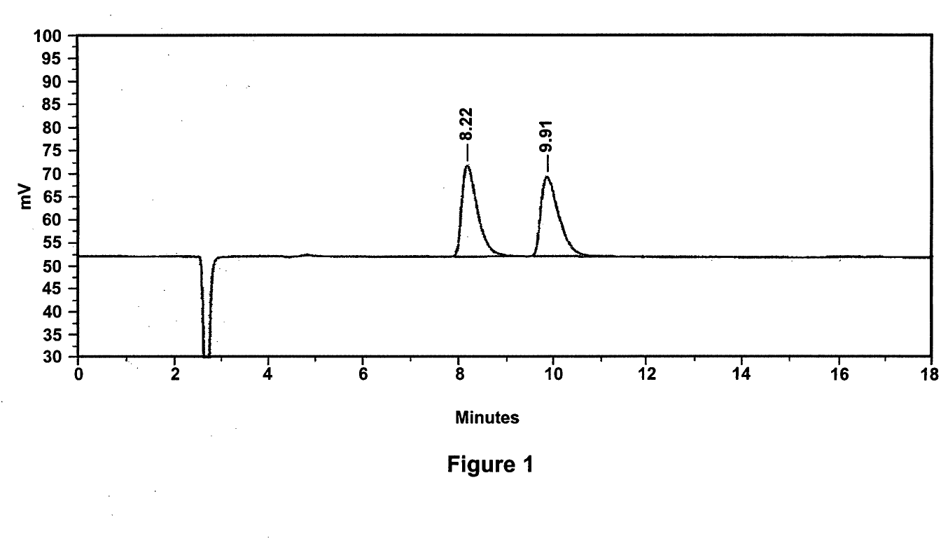

A typical chromatogram for 2-DG and glucose, each at 2 mg/mL, is shown in FIG. 1. Under the conditions of the method, 2-DG eluted at about 8 minutes, and glucose eluted between 9 and 10 minutes. Peaks eluting before 6 min were system peaks, which showed some variability run-to-run. Resolution between 2-DG and glucose was 2.4 with 3100 theoretical plates for both peaks. Both 2-DG and glucose peaks were well-shaped with an asymmetry (tailing) of 1.7.

The methods of the invention can be useful in measuring the heat stability of an aqueous API 2-DG solution. In one test, heat stability was determined by storing the solution at 60° C. for 35 days in a sealed 2 mL glass vial. The methods of the invention can also be useful in measuring the light stability of an aqueous API 2-DG solution. In one test, light stability was determined by exposing the solution to intense fluorescent light for 35 days in a sealed 2 mL glass vial.

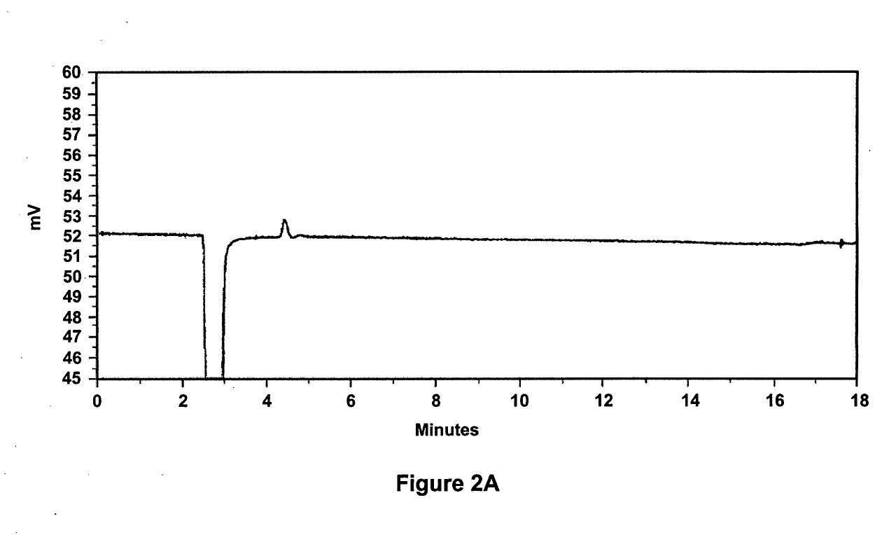

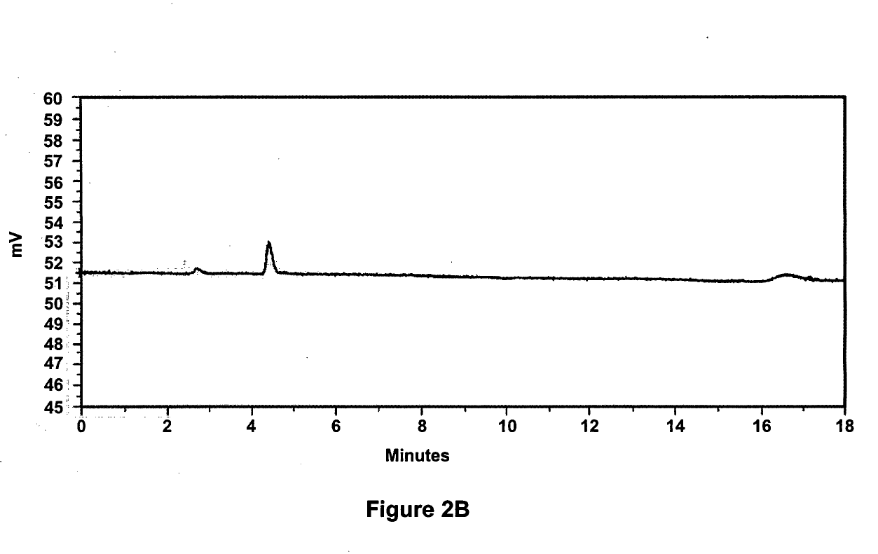

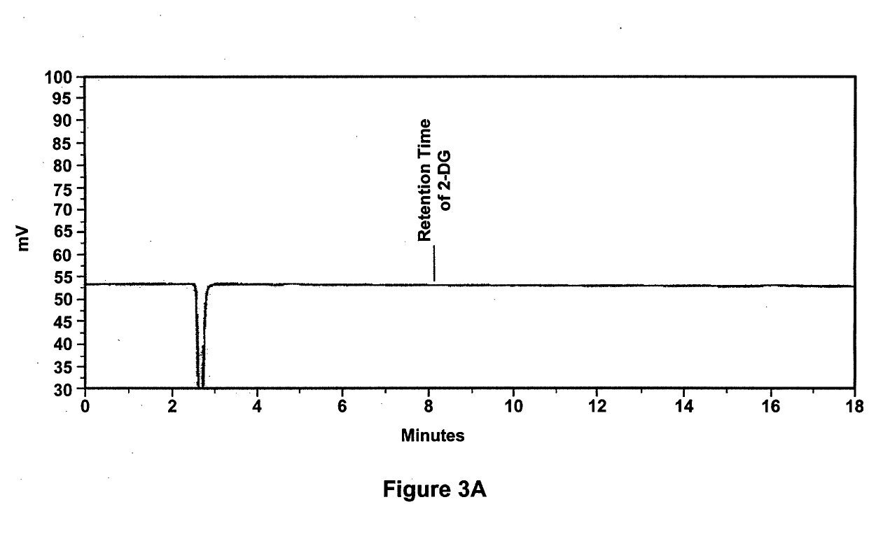

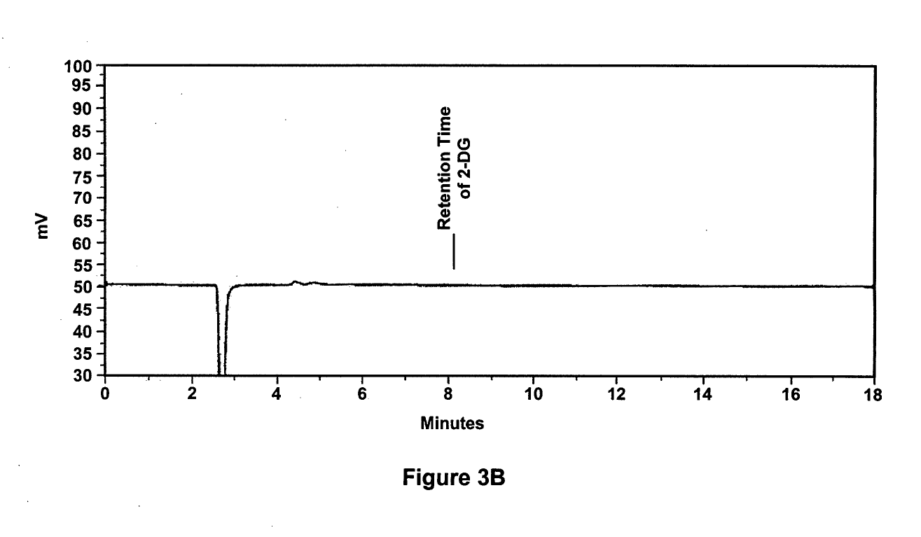

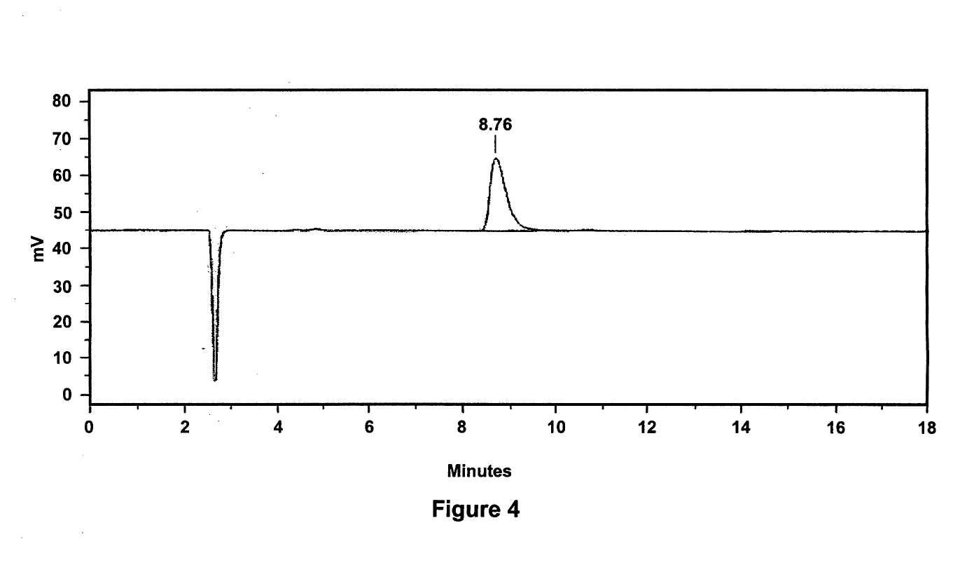

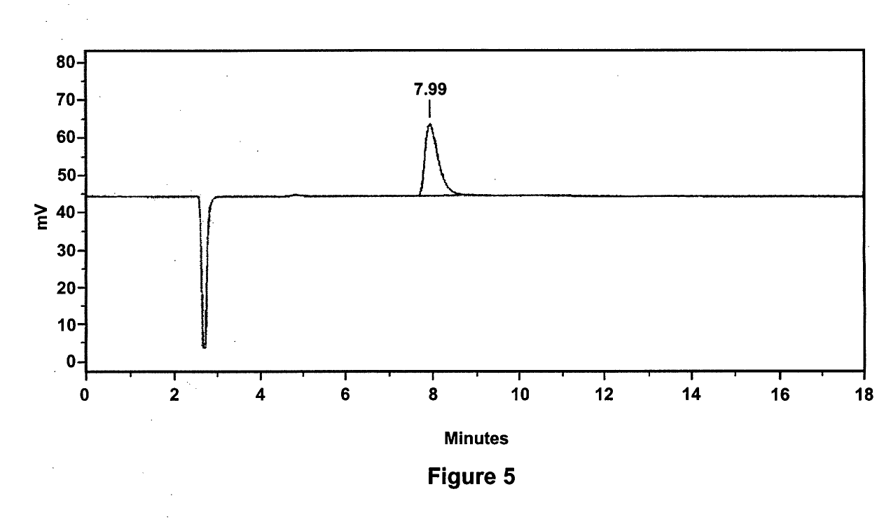

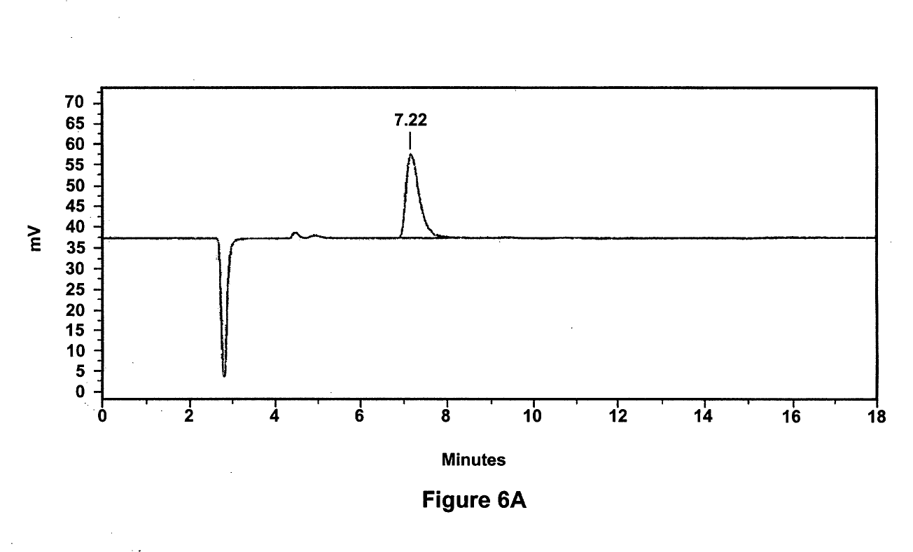

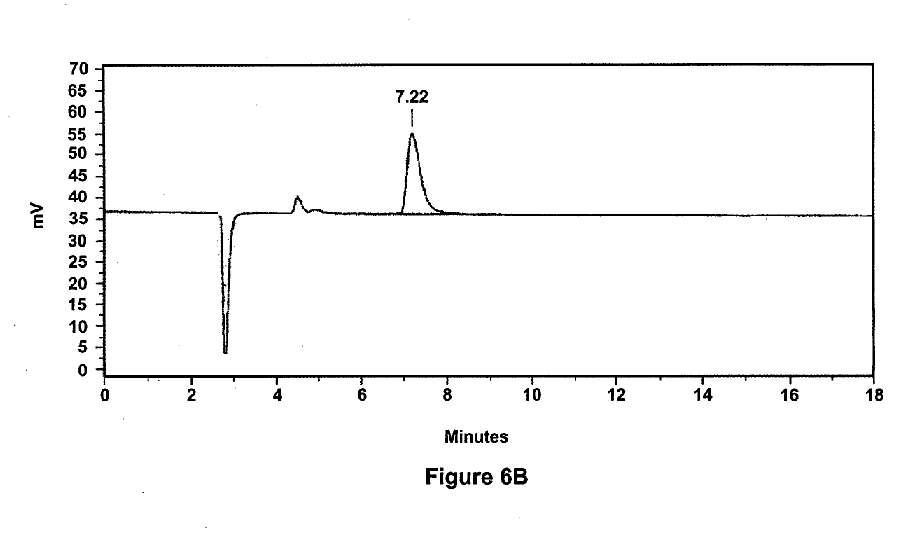

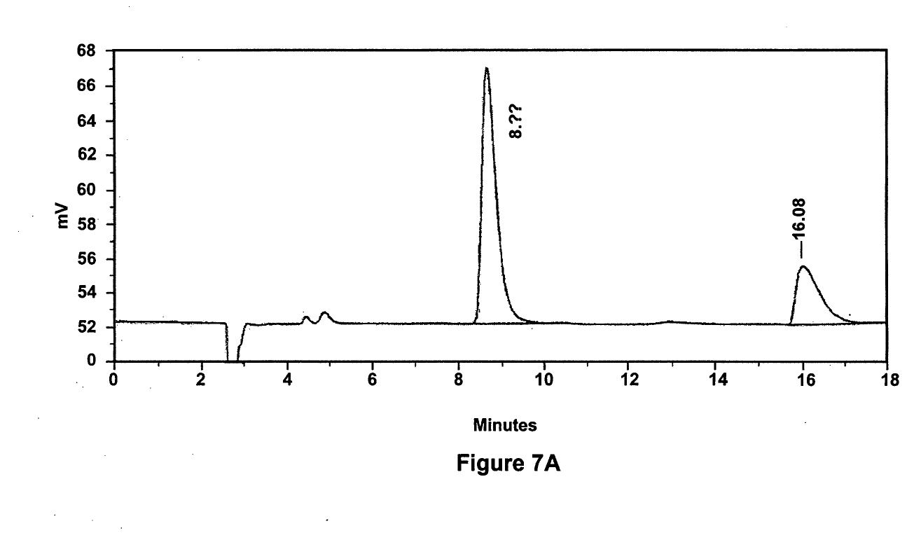

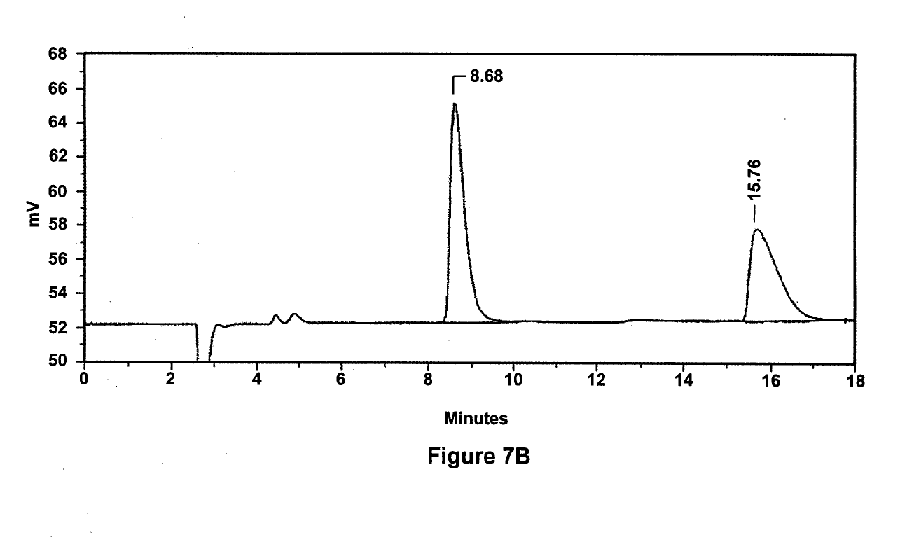

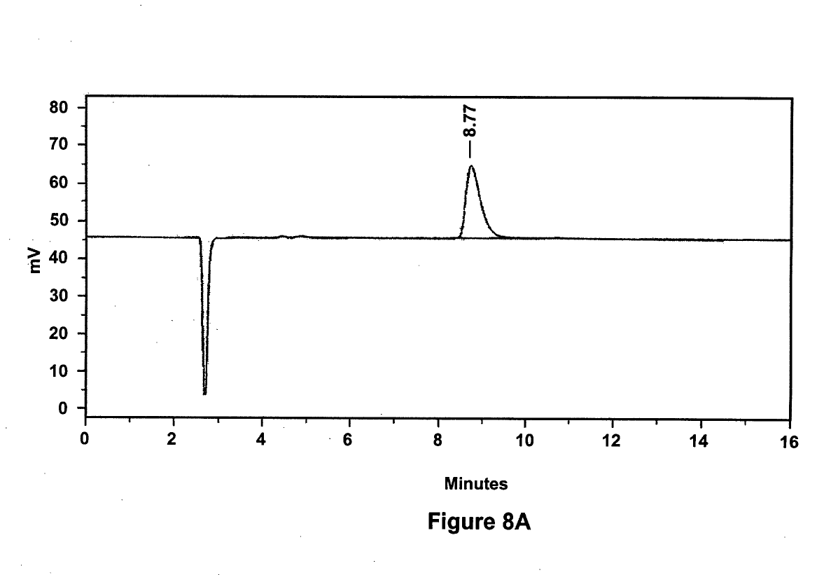

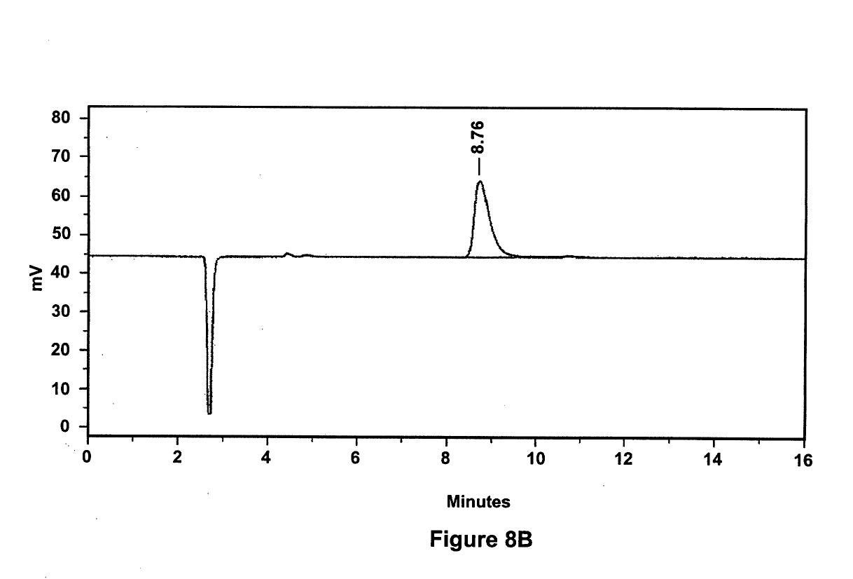

The chromatograms for blank injections of water (see FIG. 2A) and mobile phase (see FIG. 2B), placebo containing methylparaben at 1.8 mg/mL and propylparaben at 0.2 mg/mL (see FIG. 3A), and placebo degraded at 70° C. for one day (see FIG. 3B) demonstrated that the background signal did not interfere with the quantitation of 2-DG or glucose peaks. API or drug-product 2-DG was exposed to elevated heat (see FIGS. 4 and 5 respectively), acid/base (see FIGS. 6A and 6B), oxidation by H₂O₂ (see FIGS. 7A and 7B) and intense fluorescence light (see FIGS. 8A and 8B). The results showed there was no degradation in samples exposed to 60° C. or intense fluorescent light for at least 35 days; that 2-DG was stable in pH 2 or pH 10 solution stored at 60° C. for 5 days; and that there was approximately 23% and 34% degradation in 50 and 100 μL H₂O₂ added 2-DG solutions stored at 60° C. for 17 days.

### System Linearity

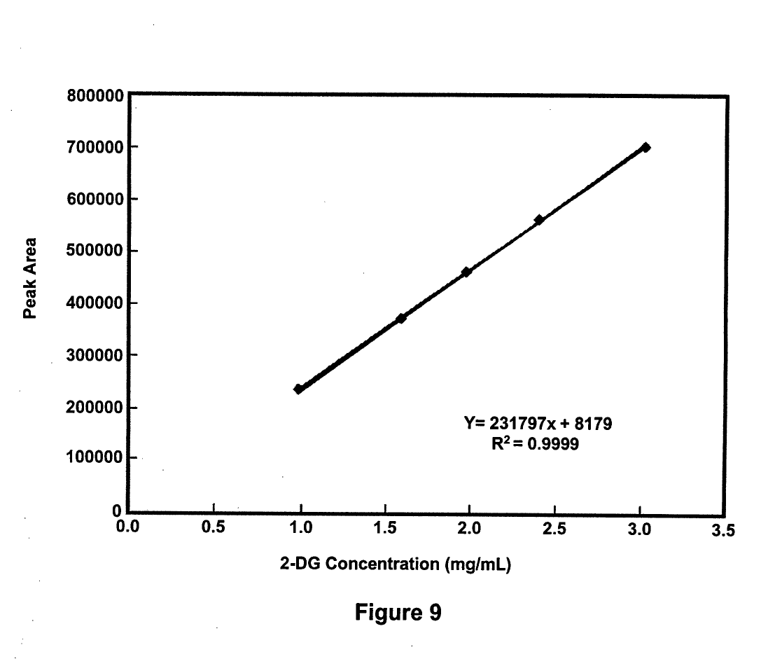

To determine system linearity for 2-DG, a series of 2-DG standard solutions in water, in the concentration range of 50-150% of the expected injectate concentration (2 mg/mL), were prepared. Triplicate injections were made for each solution. Six replicate injections were made for the injected concentration at about 2 mg/mL. Excellent linearity was observed for the measured peak area versus 2-DG concentration in the injectate, with an r² value of 0.9999, a slope of 231797 and a y-intercept of 8179 (see Table 2 and FIG. 9).

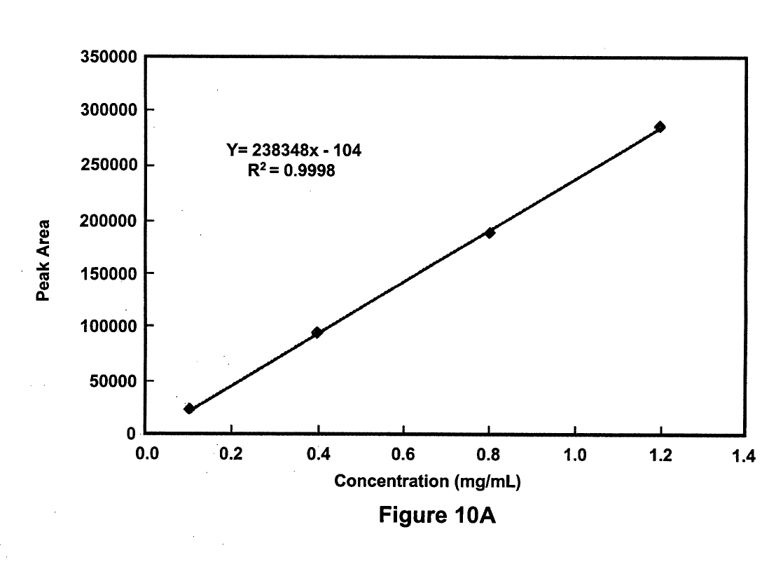

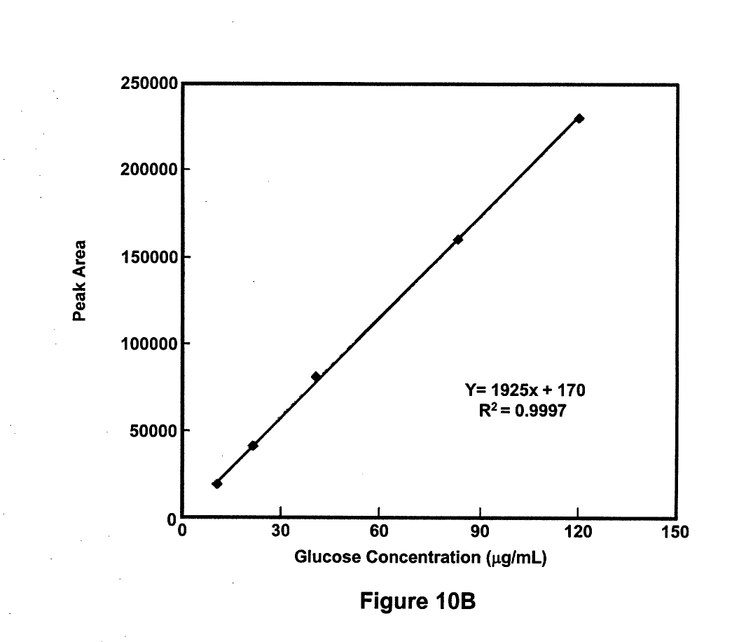

The system linearity for glucose was performed by preparing a series of glucose standard solutions in water in the concentration range of 0.1-1.2 mg/mL with 10 μL injection (see Table 3A and FIG. 10A) and 10-120 μg/mL with 80 μL injection (see Table 3B and FIG. 10B). Excellent linearity was observed for the measured peak area versus glucose concentration in the injectate, with r² values of 0.9998 and 0.9997, respectively.

TABLE 2
System Linearity of 2-DG

| 2-DG Concentration | % of Nominal | | |
|---|---|---|---|
| (mg/mL) | (2 mg/mL) | Peak Area | Mean ± SD |
| 1.001 | 50.1% | 240406 | 241927 ± 5011 |
| | | 247522 | |
| | | 237852 | |
| 1.603 | 80.2% | 376265 | 376437 ± 4117 |
| | | 372409 | |
| | | 380638 | |
| 1.982 | 99.1% | 468109 | 468228 ± 2531 |
| | | 467918 | |
| | | 468014 | |
| | | 467427 | |
| | | 465429 | |
| | | 472352 | |
| 2.412 | 120.6% | 565828 | 568212 ± 2116 |
| | | 568940 | |
| | | 569868 | |
| 3.030 | 151.5% | 707758 | 710550 ± 4102 |
| | | 715259 | |
| | | 708633 | |

Slope = 231797
Y-intercept = 8179
R² = 0.9999

TABLE 3A
System Linearity for Glucose (10 μL Injection)

| Glucose | | | |
|---|---|---|---|
| Concentration | % of Nominal | | |
| (mg/mL) | (2 mg/mL) | Peak Area | Mean |
| 0.1 | 5% | 22483 | 24661 |
| | | 26838 | |
| 0.4 | 20% | 93967 | 94815 |
| | | 95662 | |
| 0.8 | 40% | 188393 | 187668 |
| | | 186943 | |
| 1.2 | 60% | 281154 | 286404 |
| | | 291653 | |

Slope = 238348
Y-intercept = −104
R² = 0.9998

TABLE 3B
System Linearity for Glucose (80 μL Injection)

| Glucose | | | |
|---|---|---|---|
| Concentration | % of Nominal | | |
| (μg/mL) | (2 mg/mL) | Peak Area | Mean |
| 10.21 | 0.51% | 19163 | 19163 |
| 21.35 | 1.07% | 42408 | 40877 |
| | | 39345 | |
| 40.07 | 2.00% | 78327 | 80533 |
| | | 82738 | |
| 83.00 | 4.15% | 160186 | 160622 |
| | | 161057 | |
| 119.5 | 5.98% | 231600 | 229933 |
| | | 228265 | |

Slope = 1925
Y-intercept = 710
R² = 0.9997

### Determination of System Precision

A 2-DG standard solution at 1.98 mg/mL was injected six times and the peak areas (mAU•sec) determined (see Table 4). The relative standard deviation (RSD) was 0.5%.

TABLE 4
System Precision

| | Peak | | |
|---|---|---|---|
| Sample No. | Area(mAU · sec) | Mean ± SD | RSD |
| 1 | 468109 | | |
| 2 | 467918 | | |
| 3 | 468014 | 468228 ± 2531 | 0.5% |
| 4 | 467427 | | |
| 5 | 465429 | | |
| 6 | 472352 | | |

### Determination of System Suitability

System suitability was determined by six replicate injections of a system suitability-resolution solution. The RSD of the peak area and retention time of 2-DG were 0.8% and 0.0%, respectively. The RSD of the peak area and the retention time of glucose were 0.7% and 0.0%, respectively (see Table 5). The average resolution between 2-DG and glucose was 2.79±0.01 (n=6).

TABLE 5
System Suitability of 2-DG and Glucose

| | | | | Glucose | |
|---|---|---|---|---|---|
| | 2-DG | 2-DG | Glucose | Retention | |
| Injection | Peak Area | Retention | Peak Area | Time | Reso- |
| No. | (mAU · S) | Time (min) | (mAU · S) | (min) | lution |
| 1 | 458700 | 8.8 | 489136 | 10.6 | 2.78 |
| 2 | 453843 | 8.8 | 493462 | 10.6 | 2.78 |
| 3 | 458488 | 8.8 | 491759 | 10.6 | 2.80 |
| 4 | 454905 | 8.8 | 489158 | 10.6 | 2.79 |
| 5 | 458445 | 8.8 | 492504 | 10.6 | 2.80 |
| 6 | 451052 | 8.8 | 484803 | 10.6 | 2.79 |
| Mean | 453347 | 8.8 | 490337 | 10.6 | 2.79 |
| SD | 3821 | 0.0 | 3482 | 0.0 | 0.01 |
| RSD | 0.8% | 0.0% | 0.7% | 0.0% | 0.4% |

### Determination of Accuracy

A known amount of 2-DG reference standard was dissolved in placebo to yield solutions containing 2-DG at 80, 100, and 120 mg/mL. Triplicate samples were prepared for each concentration. Solutions were diluted to 2 mg/mL with water and assayed. The accuracy of this method was determined by evaluating solutions of 2-DG at concentrations of 80%, 1 00% and 120% of solutions at 100 mg/mL. Recoveries were in the range of 101.3-102.8% (see Table 6).

TABLE 6
Accuracy (Nominal Concentration: 100 mg/mL)

| % of | 2-DG Concentration mg/mL | | % | |
|---|---|---|---|---|
| Nominal | Expected | Found | Recovery | Mean ± SD |
| 80% | 77.65 | 81.86 | 102.8 | 102.4 ± 0.8 |
| | 79.07 | 80.24 | 101.5 | |
| | 79.47 | 81.72 | 102.8 | |
| 100% | 99.02 | 100.90 | 101.9 | 102.2 ± 0.5 |
| | 98.40 | 101.15 | 102.8 | |
| | 99.18 | 101.14 | 102.0 | |
| 120% | 118.8 | 120.98 | 101.8 | 101.5 ± 0.3 |
| | 118.1 | 119.76 | 101.4 | |
| | 119.5 | 121.02 | 101.3 | |

### Determination of Method Precision

Method precision was assessed by assaying two API lots on four different days in the same laboratory. The same HPLC system and column were used for all assays. The results indicate that the percent purity in both lots was very similar on four assay days, and that the method had good precision (see Table 7).

TABLE 7
Method Precision (2-DG API)

| | % Purity | |
|---|---|---|
| Assay Date | Lot 28445A | Lot 28506A |
| Mar. 6, 2003 | 98.0 | 98.9 |
| Mar. 7, 2003 | 97.6 | 98.7 |
| Mar. 13, 2003 | 97.9 | 99.4 |
| Mar. 21, 2003 | 98.6 | 99.2 |
| Mean = | 98.0 | 99.1 |
| SD = | 0.4 | 0.3 |

### Limit of Detection and Quantitation of Glucose

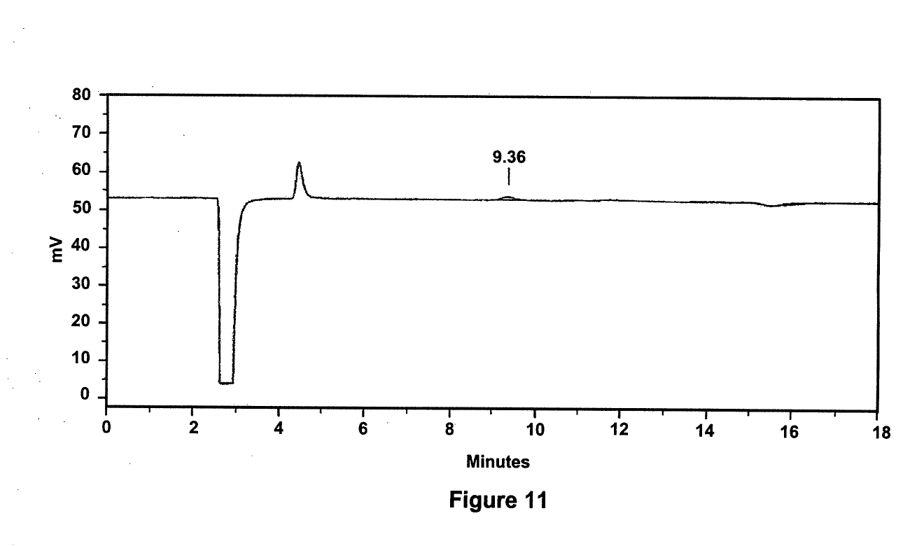

A signal-to-noise (S/N) ratio of 3:1 is generally defined as the limit of detection. The S/N ratio for an 80-μL injection of glucose sample at 10 μg/mL (or 0.5% of 2-DG at 2 mg/mL), was determined to be 6.7 (FIG. 11). Therefore the limit of detection (LOD, defined as 3•S/N) was calculated to be:
10 μg/mL×(3/6.7)=4.5 μg/mL. The limit of quantitation (LOQ, defined as 10•S/N) was 15 μg/mL.

### Ruggedness and Robustness

The 2-DG standard and resolution solutions at a nominal concentration of 2 mg/mL were re-assayed versus a freshly-prepared standard solution. The results showed both solutions were stable after storage at ambient room temperature for 4 days (see Table 8A. 2-DG injectate solutions from two lots were re-assayed after stored at 5° C. for 7 days. The results indicate both solutions were stable (see Table 8B.

TABLE 8A
Robustness/Ruggedness: Stability of
Standard and Resolution Solutions

| | 2-DG Concentration (mg/mL and % of Initial) | |
|---|---|---|
| | Initial | 4 days RT |
| Standard Solution | 2.026 mg/mL | 2.035 mg/mL |
| (≈2 mg/mL) | (100.0%) | (100.4%) |
| Resolution Solution | 2.158 mg/mL | 2.125 mg/mL |
| (≈2 mg/ml) | (100.0%) | (98.5%) |

TABLE 8B
Robustness/Ruggedness: Stability of Injectate Solutions

2-DG Concentration (mg/mL and % of Initial)

| | Initial | 7 days at 5° C. |
|---|---|---|
| Lot # 28445A | 2.07 mg/mL | 2.03 mg/mL |
| | (100.0%) | (98.1%) |
| Lot # 28506A | 2.02 mg/mL | 1.98 mg/mL |
| | (100.0%) | (98.0%) |

The effects of variation of the NaOH concentration in the mobile phase, column temperature (25° C. and 35° C.), and flow rate (0.6, 0.8 and 1.0 mL/min), on 2-DG retention time, and the resolution between 2-DG and glucose (see Tables 9A and 9B were also determined. Variation in 2-DG retention time was observed with chromatography conditions, but in all cases, the resolution was greater than 2.0.

TABLE 9A
Robustness/Ruggedness: Effects of Variation on the
NaOH Concentration in Mobile Phase, Column Temperature
and Flow Rate on 2-DG Retention Time

| | | 2-DG Retention Time | | |
|---|---|---|---|---|
| Mobile | Column | (min) with Flow Rate at | | |
| Phase | Temperature | 0.6 mL/min | 0.8 mL/min | 1.0 mL/min |
| 20 mM NaOH | 35° C. | 9.09 | 7.35 | 6.17 |
| 16 mM NaOH | 25° C. | 11.24 | 8.32 | 6.54 |

TABLE 9B
Robustness/Ruggedness: Effects of Variation on the
NaOH Concentration in Mobile Phase, Column Temperature
and Flow Rate on Resolution of 2-DG and Glucose

| Mobile | Column | Resolution with Flow Rate at | | |
|---|---|---|---|---|
| Phase | Temperature | 0.6 mL/min | 0.8 mL/min | 1.0 mL/min |
| 20 mM NaOH | 35° C. | 2.55 | 2.60 | 2.54 |
| 16 mM NaOH | 25° C. | 2.81 | 2.61 | 2.43 |

### Example 2

This example illustrates how 2-DG purity was assessed in a mixture containing 2-DG, glucose, and tri-O-acetyl-D-glucal (glucal), in accordance with an embodiment of the method of the invention in which aqueous NaOH was the mobile phase, an RCX-10 anion exchange column was the stationary phase, an electrochemical (EC) detector was employed, and the concentration of 2-DG in the 2-DG solution analyzed was about 10 μg/mL. Acceptable separation of 2-DG and glucose was obtained with 10-50 mM NaOH being employed as the mobile phase. An increase in NaOH concentration decreased retention time for 2-DG and glucose. With 47 mM NaOH in the mobile phase, the following result was obtained (see Table 10).

TABLE 10

| | 2-DG | glucose | glucal |
|---|---|---|---|
| Concentration | 10 μg/mL | 1 μg/mL | 50 μg/mL |
| Peak Area | 17,683,388 | 15,033,551 | |
| Retention Time | 8.6 min | 10.2 min | 14.8 min |
| Note | Good sharp peak | Good sharp peak | Slight tailing |

### Example 3

This example illustrates how 2-DG purity was assessed in a solution containing 2-DG, glucose, and glucal in accordance with an embodiment of the method of the invention in which aqueous NaOH was the mobile phase, an RCX-30 anion exchange column was the stationary phase and an EC detector was employed (see Table 11). The peak corresponding to glucal dissolved in 30 mM NaOH (50 μg/mL) was a sharp large peak with retention time at about 11 minutes, possibly because of a hydrolysis of the glucal to 2-DG in the alkaline solution. However, the same sample dissolved in water resulted in a poorly-shaped, small peak.

TABLE 11

| Mobile Phase | | Retention Time | Retention Time |
|---|---|---|---|
| (NaOH) | Sample Dissolved in | (2-DG) | (glucose) |
| 40 mM | water | 10 min | 14 min |
| 30 mM | water | 13 min | 18 min |
| 40 mM | 30 mM NaOH | 9-10 min | 13 min |

### Example 4

This example illustrates how 2-DG purity was assessed in a mixture containing 2-DG and glucose in accordance with an embodiment of the method of the invention in which aqueous acid was the mobile phase, an aminex column was the ion exchange column and an EC detector was employed (see Table 12). This example further illustrates how 2-DG purity was assessed in a solution containing 2-DG and glucal in accordance with an embodiment of the method of the invention in which water was the mobile phase, an aminex column was the ion exchange column, and an EC detector was employed.

TABLE 12

| Column | Mobile Phase | Retention time |
|---|---|---|
| Aminex | 0.009N H₂SO₄ | 8.4 min (glucose) |
| HPX-87H | | 9.5 min (2-DG) |
| Aminex | water | 13.3 min (glucal) |
| HPX-87N | | 10.2 min (2-DG) |

What is claimed is:

1. An HPLC method for analyzing purity of crystalline 2-deoxy-D-glucose (2-DG), said method comprising the steps of:
(a) dissolving said crystalline 2-DG in an aqueous solution;
(b) chromatographing a sample of said aqueous 2-DG solution on an ion exchange column using an eluent selected from the group consisting of water, aqueous alkali, and aqueous acid;
(c) measuring an amount of 2-DG and any impurities in said sample after said chromatography by means of a detector that generates a signal proportional to the amount of said 2-DG in said sample; and
(d) determining the purity of said crystalline 2-DG by comparing the signal generated by said 2-DG with any signal generated by said impurities in said sample.

2. The method of claim 1, wherein said chromatography performed in step (b) employs an anion exchange column and aqueous alkali eluent.

3. The method of claim 1, wherein said chromatography performed in step (b) employs an ion exchange column and aqueous acid eluent.

4. The method of claim 1, wherein said chromatography performed in step (b) employs an ion exchange column and water eluent.

5. The method of claim 1, wherein said chromatography performed in step (b) employs an ion exchange column and water eluent.

6. The method of claim 5, wherein said aqueous solution contains between 1 μg/mL and 10 mg/mL of said crystalline 2-DG.

7. An HPLC method for analyzing purity of 2-DG in an aqueous solution said method comprising the steps of:
(a) chromatographing a sample of said aqueous 2-DG solution on an ion exchange column using an eluent selected from the group consisting of water, aqueous alkali, and aqueous acid;
(b) measuring an amount of 2-DG and any impurities in said sample after said chromatography by means of a detector that generates a signal proportional to the amount of said 2-DG in said sample but that is not an ultra-violet detector; and
(c) determining the purity of said 2-DG by comparing the signal generated by said 2-DG with any signal generated by said impurities in said sample.

8. The method of claim 7, wherein said chromatography performed in step (b) employs an anion exchange column and aqueous alkali eluent.

9. The method of claim 7, wherein said chromatography performed in step (b) employs an ion exchange column and aqueous acid eluent.

10. The method of claim 7, wherein said chromatography performed in step (b) employs an ion exchange column and water eluent.

11. The method of claim 8, wherein said detector of step (c) is an RI detector or a pulsed amperometric detector.

12. The method of claim 11, wherein said aqueous solution contains between 1 μg/mL and 10 mg/mL of 2-DG.

13. The method of claim 1, wherein said crystalline 2-DG is a sample of active pharmaceutical ingredient.

14. The method of claim 7, wherein a concentration of 2-DG in said sample is determined.

15. The method of claim 7, wherein said sample of 2-DG is a sample of a drug product.
